(19) United States
(12) Patent Application Publication
(10) Pub. No.: US 2010/0017795 A1
(43) Pub. Date: Jan. 21, 2010

(54) SERVER, TERMINAL, AND METHOD FOR SOFTWARE GROUP SERVICE

(75) Inventors: Sung-Joo Kang, Seoul (KR); Jeong-Min Shim, Daejon (KR); Sung-Jin Hur, Daejon (KR); Wan Choi, Daejon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, DAEJON (KR)

(21) Appl. No.: 12/517,451

(22) PCT Filed: Dec. 3, 2007
(86) PCT No.: PCT/KR07/06213

§ 371 Date: Jun. 3, 2009

(30) Foreign Application Priority Data
Dec. 4, 2006 (KR) 10-2006-0121365
Oct. 2, 2007 (KR) 10-2007-009417

(51) Int. Cl. G06F 9/445; G06F 17/30; G06F 9/44

(52) U.S. Cl. 717/171; 707/3; 717/178; 707/E17.108

(57) ABSTRACT

Provided are a server, a terminal, and a method for providing a software group service. The software group service server includes: a software storing unit for storing a plurality of software; a software group managing unit for grouping software stored in the software storing unit by user and managing lists of the grouped software; a web service providing unit for inquiring a software group list requested from a user to the software group managing unit and provides the requested software group list to the terminal; and a software group providing unit for receiving a request of a software group service from the terminal, searching a corresponding software group from the software storing unit, and providing the searched software group to the terminal.

### TECHNICAL FIELD

The present invention relates to a server, a terminal, and a method for providing a software group service; and, more particularly, to a server, a terminal, and a method for providing a software group service, which group a plurality of related software by user, manage the software groups by users, and provide a corresponding software group according to a user's request in real time through a wired/wireless network in order to enable a user to use software without directly installing the software.

This work was supported by the Information Technology (IT) research and development program of the Korean Ministry of Information and Communication (MIC) and/or the Korean Institute for Information Technology Advancement (IITA) [2005-S-007-02, “A Development of Open Software Based On-Demand Officeware Deployment Technologies”].

### BACKGROUND ART

In general, package based software is installed on a personal computer (PC) through a compact disk (CD) or a downloaded software installation file. Here, the package based software is software installed through a MS installer in a Microsoft windows operating system or software installed through a RPM in Linux operating system.

Such a way of installing software requires a user's participation. That is, it is an annoying and inconvenient process for a user because the user must manually install software.

In order to eliminate such inconvenience, a streaming technology was introduced. The streaming technology enabled a user to receive software as a service through a network.

In the streaming technology, binary data, which will be installed in a personal computer, is repackaged and stored in a server. The server transmits a corresponding binary data to a client such as a terminal according to a user's request. Accordingly, a user can use necessary software without installing the software.

The streaming technology according to the related art was introduced in Korea Patent Publication 2001-0101982 published at Nov. 15, 2001, entitled “System and Method for Executing Software Program in Distributed Computing Environment” and Korea Patent Publication 2005-0014084 published at Feb. 7, 2005, entitled “System for Repackaging Application Software for Streaming of Application Software and Method thereof”.

In the streaming technologies according to the related art, a web server provides a software list to a user. The user searches necessary software from the software list and requests a related service to the web server. Then, the web server provides the requested individual software to the user.

Since the user is required to search necessary software from the software list provided from the web server in the streaming technologies according to the related art, it was still inconvenient for a user to directly search the necessary software.

### DISCLOSURE

### Technical Problem

An embodiment of the present invention is directed to providing a server, a terminal, and a method for providing a software group service, which group a plurality of related software by user, manage the software groups by users, and provide a corresponding software group according to a user's request in real time through a wired/wireless network in order to enable a user to use software without directly installing the software.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a software group service server including: a software storing unit for storing a plurality of software; a software group managing unit for grouping software stored in the software storing unit by user and managing lists of the grouped software; a web service providing unit for inquiring a software group list requested from a user to the software group managing unit and provides the requested software group list to the terminal; and a software group providing unit for receiving a request of a software group service from the terminal, searching a corresponding software group from the software storing unit, and providing the searched software group to the terminal.

In accordance with another aspect of the present invention, there is provided a software group service terminal including: a web browser for inquiring a software group list to an external software portal server and transferring the inquired software group list; and a software service providing unit for requesting a software group corresponding to the software group list transferred from the web browser to the software portal server, and receiving a corresponding software group in real time.

In accordance with another aspect of the present invention, there is provided a software group service providing method, including the steps of: storing a plurality of software; grouping the stored software by a user and managing a list of the grouped software; inquiring a requested software group list from a software group service terminal and providing the inquired software group list to the software group service terminal; and receiving a request of a software group service from the software group service terminal, searching a corresponding software group, and providing the searched software group to the software group service terminal.

In accordance with another aspect of the present invention, there is provided a software group service providing method including the steps of: requesting a software group list through a web page provided from a software portal server and receiving a corresponding software group list; and requesting a plurality of software in the provided software group list to the software portal server and receiving the corresponding software group in real time.

### ADVANTAGEOUS EFFECTS

A server, a terminal, and a method for a software group service according to the present invention provide a plurality of software to a user in a lump. Therefore, a user is not required to individually search and request necessary software according to the present invention. And, a user also can conveniently use a software service according to the present invention.

Furthermore, a user is enabled to create a working environment without installing all of software again in a user terminal when the user sets a new terminal or resets a terminal that has not been used for a long time by providing a group of software to a user in lump based on the recorded information.

Moreover, a time of executing software can be reduced and a memory space of a user terminal can be saved because the software can be executed without installing.

### BRIEF DESCRIPTION OF THE DRAWINGS

FIG. 1 is a diagram illustrating a software portal server in a software group service system in accordance with an embodiment of the present invention.

FIG. 2 is a diagram illustrating a user terminal of a software group service system in accordance with an embodiment of the present invention.

FIG. 3 is a diagram illustrating a software group service method according to an embodiment of the present invention.

### BEST MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

A software group service system according to the present invention provides a plurality of corresponding software according to a user request in real time through a wired/wireless network. The software group service system according to the present embodiment includes a software portal server and a user terminal having a communication module for communicating with the software portal server through a wired/wireless network. Herein the user terminal may be a personal computer (PC) and a personal digital assistant (PDA).

Here, one of representative technologies for providing a service in real time through a wired/wireless network is a software streaming technology.

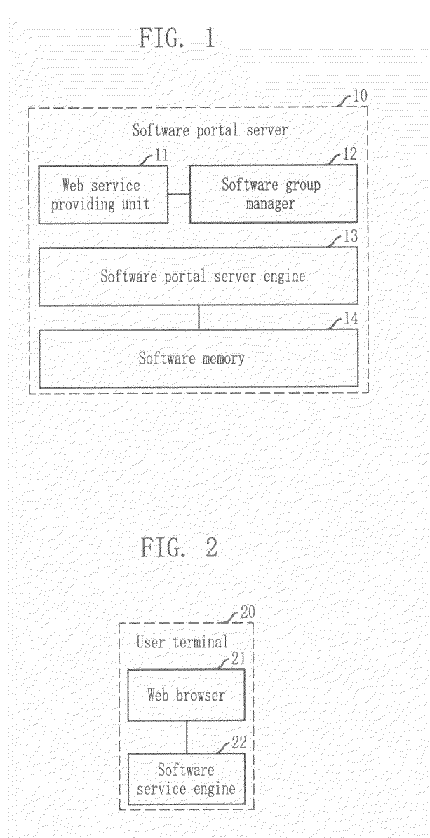

Hereinafter, a software group service system according to the present invention will be described with reference to FIGS. 1 and 2.

FIG. 1 is a diagram illustrating a software portal server in a software group service system in accordance with an embodiment of the present invention.

As shown in FIG. 1, the software portal server 10 according to the present embodiment includes a web service providing unit 11, a software group manager 12, a software portal server engine 13, and a software memory 14. The web service providing unit 11 provides a web page to a user terminal 10 through a wired/wireless network, authenticates a user through a user ID, a password, and a certification, inquires a software group list of an authenticated user from the software group manager 12, and provides the corresponding software group list to a user. The software group manager 12 manages a list of software groups by user. The software portal server engine 13 provides a service in real time to a user terminal 20 through a wired/wireless network. The software memory 14 stores software and updates the stored software to the latest version.

Here, a software group denotes a set of software, and the software group manager 12 manages the software groups by user.

The software group manager 12 groups a plurality of software stored in the software memory 14 by user and manages the lists of grouped software. Here, the software group manager 12 records a plurality of software selected by a user when the user registers as a group and manages the grouped software by user. Or, the software group manager 12 records and manages a plurality of software that are serviced to a user 1 (previously used) as a group.

FIG. 2 is a diagram illustrating a user terminal of a software group service system in accordance with an embodiment of the present invention.

As shown in FIG. 2, the user terminal 20 according to the present embodiment includes a web browser 21 and a software service engine 22. The web browser 21 enables a user to receive a web page from the software portal server 10 and to inquiry a corresponding software group list from the software portal server 10. The web browser 21 also receives the inquired the inquired software list from the software portal server 10 and transfers the inquired software list to the software serve engine 22. The software service engine 22 provides the software group list from the web browser 21 to a user. Then, the software service engine 22 requests a plurality of necessary software in the software group list to the software portal server 10 and receives a plurality of the requested software (software group) from the software portal server 10 in real time.

Here, the software service engine 22 requests a plurality of corresponding software (software group) in the software group list to the software portal server 10 and receives all of the requested corresponding software (software group). Or, the software service engine 22 may determine whether a plurality of requested software (software group) are already installed in the user terminal 20 or not and receives a plurality of software that are not installed in the user terminal 20 except the software installed in the user terminal 20.

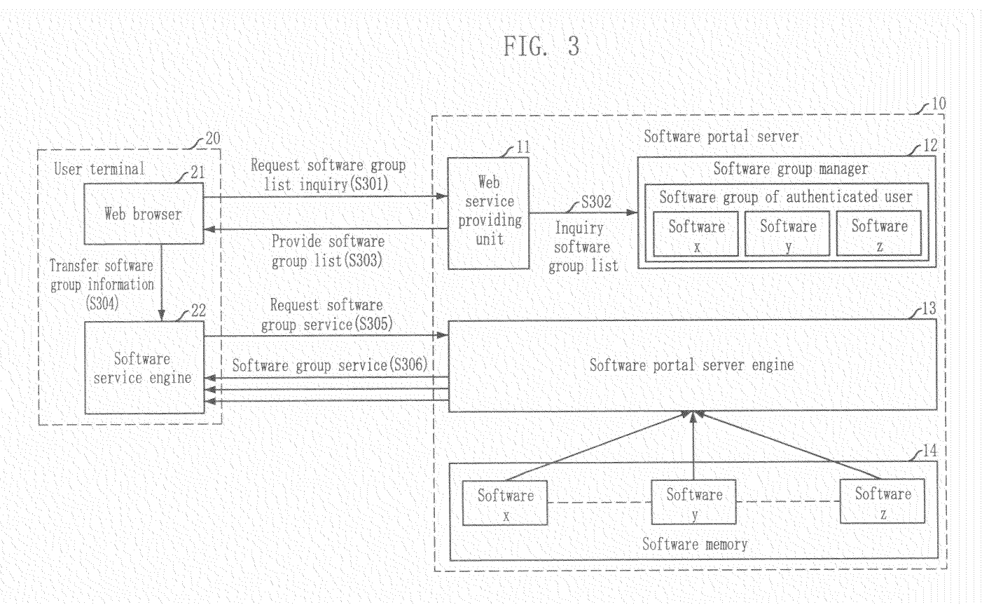

FIG. 3 is a diagram illustrating a software group service method according to an embodiment of the present invention.

At first, a user requests a software group list to the web service providing unit 11 of the software portal server 10 through the web browser 21 of the user terminal 20 at step S301.

Then, the web service providing unit 11 of the software portal server 10 authenticates a user who requests the software group list and inquires the software group list of a corresponding unit to the software group manager 12 at step S302.

The web service providing unit 11 of the software portal server 10 provides the inquired software group list (software x, y, and z) to the web browser 21 of the user terminal 20 at step S303.

Then, the web browser 21 of the user terminal 20 transfers the software group list (software x, y, and z) of a corresponding user provided from the software portal server 10 to the software service engine 22 of the user terminal at step S304.

The software service engine 22 of the user terminal 20 requests the software x, y, and z in the received software group list from the web browser 21 to the software portal service engine 13 of the software portal server 10 at step S305.

The software portal server engine 13 of the software portal server 10 searches the request software group (software x, y, and z) from the software memory 14 and provides the searched software to the software service engine 22 of the user terminal 20 at step S306.

For example, when a user accesses the software portal server 10 and individually uses a Microsoft word, a power point, a photo-shop, and an acrobat reader, the software portal server 10 automatically records and manages the MS word, the MS power point, the photo shop, and the acrobat reader as the software group of the corresponding user. When the user accesses the software portal server 10 again, the software portal server 10 provides the recorded software group, that is, the MS word, the MS power point, the photo shop, and the acrobat reader.

Or, a user may set a MS word, a MS power point, a photo-shop, and an acrobat reader as a software group named “my own office” when a user initially registers at the software portal server 10. The software portal server 10 records and manages a MS word, a MS power point, a photo-shop, and an acrobat reader as one group. Then, when the user accesses the software portal server 10 again, the software portal server 10 provides the software group (that is, a Microsoft word, a Microsoft power point, a photo shop, and an acrobat reader) to the user in a lump.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean Patent Application Nos. 2006-0121365 and 2007-0099417, filed in the Korean Intellectual Property Office on Dec. 4, 2006, and Oct. 2, 2007, respectively, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A software group service server comprising:
a software storing means for storing a plurality of software;
a software group managing means for grouping software stored in the software storing means by user and managing lists of the grouped software;
a web service providing means for inquiring a software group list requested from a user to the software group managing means and provides the requested software group list to the terminal; and
a software group providing means for receiving a request of a software group service from the terminal, searching a corresponding software group from the software storing means, and providing the searched software group to the terminal.

2. The software group service server of claim 1, wherein the web service providing means provides a web page to the terminal, authenticates a user based on user information inputted through the web page, inquires the software group list of the authenticated user from the software group managing means, and provides the software group list to the terminal.

3. The software group service server of claim 2, wherein the software storing means updates the stored software to the latest version.

4. The software group service server of claim 3, wherein the software group managing means records a plurality of software as a group, which are set by a user when the user initially registers.

5. The software group service of claim 4, wherein the software group managing means automatically record a plurality of software used by the user as one group and manages the recorded software groups.

6. A software group service terminal comprising:
a web browsing means for inquiring a software group list to an external software portal server and transferring the inquired software group list; and
a software service providing means for requesting a software group corresponding to the software group list transferred from the web browsing means to the software portal server, and receiving a corresponding software group in real time.

7. The software group service terminal of claim 6, wherein if one or more corresponding software in the software group list are installed in the software group service terminal, the software group service terminal requests software that are not installed in the software group servicer terminal to the software portal server and receives the requested software group in real time.

8. A software group service providing method, comprising the steps of:
storing a plurality of software;
grouping the stored software by a user and managing a list of the grouped software;
inquiring a requested software group list from a software group service terminal and providing the inquired software group list to the software group service terminal; and
receiving a request of a software group service from the software group service terminal, searching a corresponding software group, and providing the searched software group to the software group service terminal.

9. The software group service providing method of claim 8, wherein in the inquiring a requested software group list, a web page is provided to the software group service terminal, a user is authenticated based on user information inputted through the web page, a software group list of the authenticated user is inquired, and the software group list is provided to the software group service terminal.

10. The software group service providing method of claim 8, wherein in the providing the searched software group to the software group service terminal, the provided software are software updated to a latest version.

11. A software group service providing method comprising:
requesting a software group list through a web page provided from a software portal server and receiving a corresponding software group list; and
requesting a plurality of software in the provided software group list to the software portal server and receiving the corresponding software group in real time.

12. The software group service method of claim 11, wherein in the requesting a plurality of software of the provided software group list, if one or more corresponding software of the software group list is installed in the software group service terminal, the software group service terminal requests software that are not installed in the software group servicer terminal to the software portal server and receives the requested software group in real time.
